(19) United States
(12) Patent Application Publication
(10) Pub. No.: US 2003/0203248 A1
(43) Pub. Date: Oct. 30, 2003

(54) Method for regenerating carbon monoxide poisoning in high temperature PEM fuel cells, and fuel cell installation

(76) Inventors: Rolf Bruck, Bergisch Gladbach (DE); Joachim Grosse, Erlangen (DE); Manfred Poppinger, Uttenreuth (DE); Meike Reizig, Bonn (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/426,822

(22) Filed: Apr. 30, 2003

Related U.S. Application Data
(63) Continuation of application No. PCT/DE01/04103, filed on Oct. 30, 2001.

(30) Foreign Application Priority Data
Oct. 30, 2000 (DE) 100 53 851.7

(51) Int. Cl. H01M 8/10; H01M 8/04; H01M 8/06

(52) U.S. Cl. 429/13; 429/17; 429/30; 429/22

(57) ABSTRACT

HT-PEM fuel cells that are constantly operated at high temperatures are less sensitive to CO contamination than PEM fuel cells that are operated at normal temperatures. It is nevertheless advantageous to regenerate possible CO contamination caused by the starting of the fuel cell. To achieve this, the HT-PEM fuel cell is operated in pulse mode for a predetermined period during the warm-up phase or at operating temperature. This permits the regeneration of the electrodes of the fuel cells, which have CO deposits. To carry out a regeneration method of a control and/or regulation device in a fuel-cell system having at least one fuel cell module that consists of a stack of HT-PEM fuel cells, with a control and/or regulation device for process management allocated thereto, the system is provided with a pulse device, which activates a pulse-mode operation for the fuel-cell stack, in dependence on at least one of several predeterminable parameters.

### CROSS-REFERENCE TO RELATED APPLICATION

This application is a continuation of copending International Application No. PCT/DE01/04103, filed Oct. 30, 2001, which designated the United States and which was not published in English.

### BACKGROUND OF THE INVENTION

1. Field of the Invention

The invention relates lies in the high-temperature fuel cell field. More specifically, the invention pertains to a method for regenerating CO poisoning in HT-PEM fuel cells. The invention also relates to a fuel cell system in which the novel regeneration method is implemented.

The term HT-PEM fuel cells is used to refer to polymer electrolyte membrane fuel cells (also known as proton exchange membrane fuel cells) which are operated at temperatures that are higher than the operating temperature of known PEM fuel cells. i.e. above the standard working temperatures of approx. 60° C. At elevated temperatures of this nature, the fuel cells are advantageously insensitive to impurities in the fuel gas, in particular CO impurities in the case of a hydrogen-rich fuel gas generated from gasoline, methanol or higher hydrocarbons. Carbon monoxide impurities are present in particular if the fuel gas is generated in a reformer from gasoline, methanol or other higher hydrocarbons.

Especially in the case of the PEM fuel cells which have hitherto been customary and which, on account of the low operating temperature compared to HT-PEM fuel cells, which is approx. 60° C., are also known as LT-PEM fuel cells (low temperature PEM), it is necessary to take measures to prevent CO poisoning of the electrodes. In particular, after the reforming step the CO content of the fuel gas which is generated has to be reduced to below 100 ppm in complex and expensive gas purification stages which follow the reformer.

German patent DE 197 10 819 C1 describes a fuel cell with an anode potential that can be varied in pulsed form, in which in particular the activity of the anode catalyst, which is reduced by carbon monoxide during operation in a fuel cell, is to be restored. This involves a pulsed change in the anode potential, with the result that carbon monoxide which has been adsorbed at the catalyst is oxidized. Furthermore, it has become known from European patent application EP 0 701 294 A1, specifically for PEM fuel cells, to connect the electrodes to an alternately changing potential. Finally, for the same purpose it is proposed in the Japanese patent application JP 10-216461 A that, during the operation of a fuel cell with a hydrogen-rich fuel gas which also contains CO, the CO be deposited at a catalytic converter in order to purify the fuel gas itself.

It is known premise in the pertinent art that gas purification is not required in HT-PEM fuel cells. An earlier international PCT publication WO 00/02156 A2, which is not prior art against this document, states that in particular what are known as HTM or HT-PEM fuel cells are able to tolerate CO impurities of up to 10,000 ppm in the fuel gas. Therefore, CO occupation can be tolerated for stationary operation. Nevertheless, it is attempted to eliminate CO occupation of the electrodes, in particular during or after start-up of the fuel cell.

### SUMMARY OF THE INVENTION

It is accordingly an object of the invention to provide an operating method for an HT-PEM fuel cell and an associated fuel cell installation which overcomes the above-mentioned disadvantages of the heretofore-known devices and methods of this general type and which provides for a fuel cell system that operates without faults and independently of CO occupation of the electrodes.

With the foregoing and other objects in view there is provided, in accordance with the invention, a method for operating an HT-PEM fuel cell, which comprises:

starting the HT-PEM fuel cell in a cold state;

operating the HT-PEM fuel cell in pulsed mode operation for a predetermined time, and selecting the time for pulsed mode operation in dependence on at least one of a poisoning state and a cell voltage of the HT-PEM fuel cell; and

thereby regenerating the HT-PEM fuel cell with the pulsed mode operation by alleviating Co poisoning.

In other words, according to the invention, the HT-PEM fuel cell is operated in pulsed mode for in each case a predetermined period of time during heating up from the cold state to the operating-temperature state. Pulsed operation sufficiently reliably ensures regeneration of any electrodes of the HT-PEM fuel cells which may be occupied with CO. This allows an HT fuel cell system to be operated without faults in long-term operation and in particular with fluctuating loads.

The measure according to the invention is therefore advantageously carried out as a function of the poisoning level, for which purpose there is a suitable sensor for detecting the poisoning level. For this purpose, it is recommended to use the cell voltage generated by the fuel cell or the change in this voltage. The measures according to the invention may preferably also be carried out as precautionary measures after each cold start, so that the formation of CO occupation at electrodes is prevented and therefore possible poisoning of the membrane electrode assemblies (MEAs) is eliminated.

In accordance with an added feature of the invention, the regenerating step comprises removing a CO poisoning from electrodes occupied by CO.

In accordance with an additional feature of the invention, the HT-PEM fuel cell is operated in pulsed mode operation while the HT-PEM fuel cell is being heated up to operating temperature. Alternatively, or in addition, it is operated in pulsed mode operation after the HT-PEM fuel cell has been heated up substantially to its operating temperature.

In accordance with another feature of the invention, the HT-PEM fuel cell is operated in pulsed mode operation after each cold start.

In the context of the invention, it is advantageous if the regeneration of the CO poisoning is carried out once per operating cycle of the HT-PEM fuel cell. In this case, the regeneration is effected by pulsed operation at temperatures of between 60° C. and 300° C., preferably between 120 and 200° C.

With the above and other objects in view there is also provided, in accordance with the invention, a fuel cell installation, particularly for performing the operating method as outline above. The fuel cell installation comprises:

at least one fuel cell module with a fuel cell stack of HT-PEM fuel cells;

a process management control device connected to said fuel cell module;

a pulsing device associated with said control device for activating said fuel cell stack into pulsed operation in dependence on predetermined parameters; and

a device for defining the predetermined parameters, said device including at least one of a device for measuring an output voltage of said fuel cell stack or a change in the output voltage and sensors for recording CO occupation in the HT-PEM fuel cells.

In accordance with again an added feature of the invention, there is provided a timer for activation of the pulsing device.

In accordance with again another feature of the invention, the activation of said fuel cell stack into pulsed operation is triggered by a given voltage change gradient of said fuel cell stack.

In accordance with a concomitant feature of the invention, the activation of said fuel cell stack into pulsed operation is sensor-controlled.

Other features which are considered as characteristic for the invention are set forth in the appended claims.

Although the invention is illustrated and described herein as embodied in a method for regenerating CO poisoning in HT-PEM fuel cells, and associated fuel cell system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a graph plotting the CO dependency of the voltage in a PEM fuel cell stack that is operated in the low-temperature range;

FIG. 2 is a graph plotting the CO dependency of the voltage for an HT-PEM fuel cell stack;

FIGS. 3 and 4 are two graphs illustrating the influence of the pulsed mode on operation of an HT-PEM fuel cell stack; and

FIG. 5 is a schematic block diagram of a fuel cell system having an HT-PEM fuel cell stack and an associated control device.

### DESCRIPTION OF THE PREFERRED EMBODIMENTS

PEM fuel cells are well known from the prior art and consequently there is no need for their structure to be described in further detail in the present context. PEM fuel cells of the generic type are substantially based on proton exchange in a solid electrolyte (proton exchange membrane). The acronym PEM is also derived from the structure of the fuel cell having a polymer electrolyte membrane. The core component of PEM fuel cells of this type is what is known as the MEA or membrane electrode assembly, in which electrodes, as cathode and anode of the fuel cell, are applied to each side of a suitable membrane made from organic material forming the electrolyte or its support.

Fuel gas, and specifically, in the case of the PEM fuel cell, hydrogen or a hydrogen-rich gas, which is obtained by means of a reformer from gasoline, methanol or a higher hydrocarbon, is reacted with oxygen to form water and charge carriers at the MEAs. Depending on the quality of the reformation, the fuel gas contains carbon impurities, in particular in the form of carbon monoxide (CO).

During the operation of a PEM fuel cell, which works at approximately 60° C., carbon monoxide (CO) constitutes a significant problem in this temperature range, since it occupies the electrodes and it poisons the catalyst located on or in the electrodes. Therefore, corresponding purification measures have to be taken for the fuel gas generated by reforming in order to prevent poisoning of the electrodes.

When a PEM fuel cell is operating at relatively high temperatures, i.e. at temperatures of over 100° C. at standard pressure, and in particular in the operating range from 120° C. to 200° C., by contrast, the quality of the fuel gas and its impurities including carbon monoxide are of less importance. In particular, impurities amounting to up to 10,000 ppm of carbon monoxide (CO) in the fuel gas can be tolerated. Nevertheless, in this case too, in particular during the start-up phase, i.e., in particular before the operating temperature of over 100° C. is reached, undesirable occupation of the electrodes with carbon monoxide may still result. This can be eliminated by pulsed operation while the fuel cell system is heating up or after it has heated up, i.e. when it is at its operating temperature.

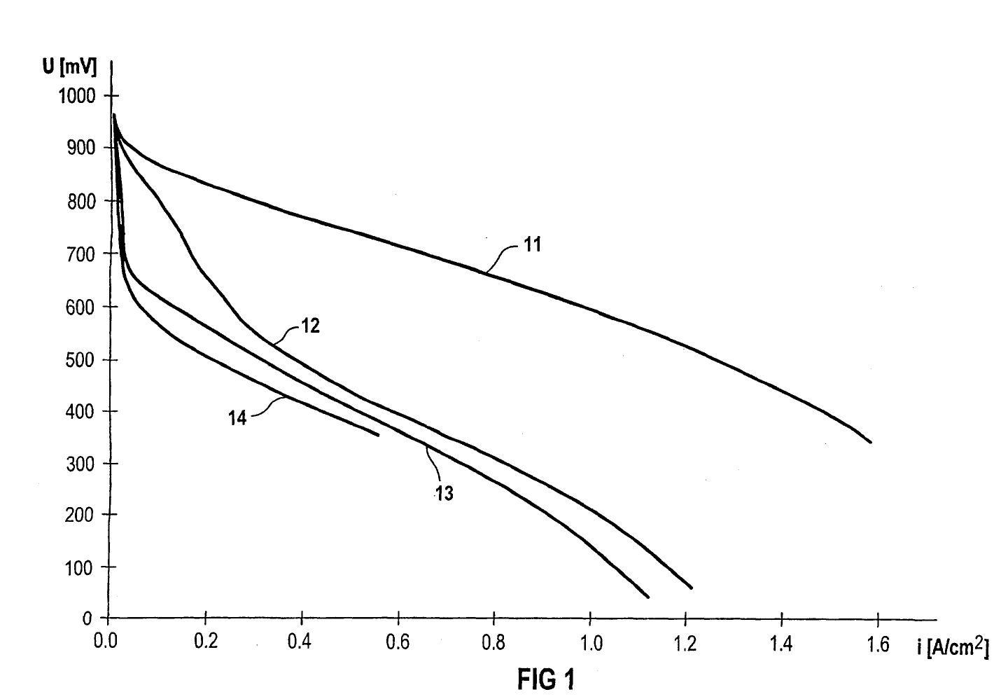

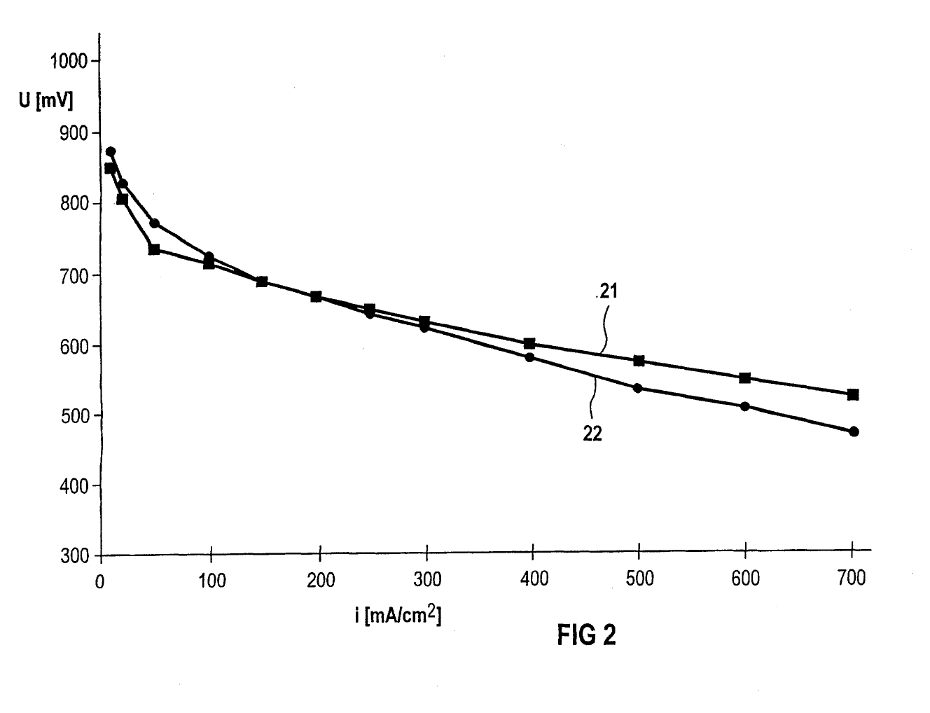

Referring now to the figures of the drawing in detail and first, particularly, to FIGS. 1 and 2 thereof, there is illustrated the voltage U in mV of a PEM fuel cell stack as a function of the current density i in A/cm² for different boundary conditions. The results in this respect are characteristic curves U=f(i), the voltages U falling steeply to zero at high current densities i.

Characteristic curves of this type are known. Furthermore, it is known that if the electrodes are occupied with CO, the fuel cells become unable to function.

FIG. 1 presents four characteristic curves 11 to 14 for low-temperature PEM fuel cells which have different CO contents as parameters, specifically, in detail,

0 ppm for characteristic curve 11,

100 ppm for characteristic curve 12,

1000 ppm for characteristic curve 13, and

10,000 ppm for characteristic curve 14.

It can be seen from these curves that at higher CO contents, leading to CO occupation of the electrodes, the voltages break down even at low current densities, for example at approx. 1.1 A/cm² in the case of 1000 ppm of CO compared to approx. 2 A/cm² for 0 ppm of CO.

FIG. 2 uses two characteristic curves 21 and 22, with 0 ppm of CO and 1000 ppm of CO, to demonstrate that for the specific case of the high-temperature PEM fuel cell the voltage/current density relationships are practically identical. This corresponds to the known fact that the HT-PEM is very substantially insensitive to contamination with CO.

If the CO poisoning is considered as a function of the temperature, particularly at low temperatures, i.e. in the low-temperature PEM fuel cell, there is a rapid drop in the cell voltage, which at high temperatures, i.e. in the case of the high-temperature PEM, moves asymptotically toward zero.

When the HT-PEM fuel cell is operating, it is now possible to eliminate potential poisoning of electrodes through the fact that, when the fuel cell is being started up from the cold state during heating-up of the fuel cell, or after the operating temperature state of the fuel cell has been reached, the HT-PEM fuel cell is operated in pulsed mode for a predetermined time. This can be achieved on the one hand by brief short-circuiting or polarity reversal and, on the other hand, by disconnecting the supply of hydrogen during operation under load.

Pulsed operation results in regeneration of the CO-occupied electrodes and therefore in each case sets the HT-PEM fuel cell to the ideal state.

It is therefore recommended to find suitable criteria for recording the poisoning state of the HT-PEM fuel cell. One such criterion which can be used is, for example, the cell voltage gradient, since a drop in the cell voltage indicates poisoning. Advantageously, therefore, pulsed operation can be carried out as a function of the drop in the cell voltage.

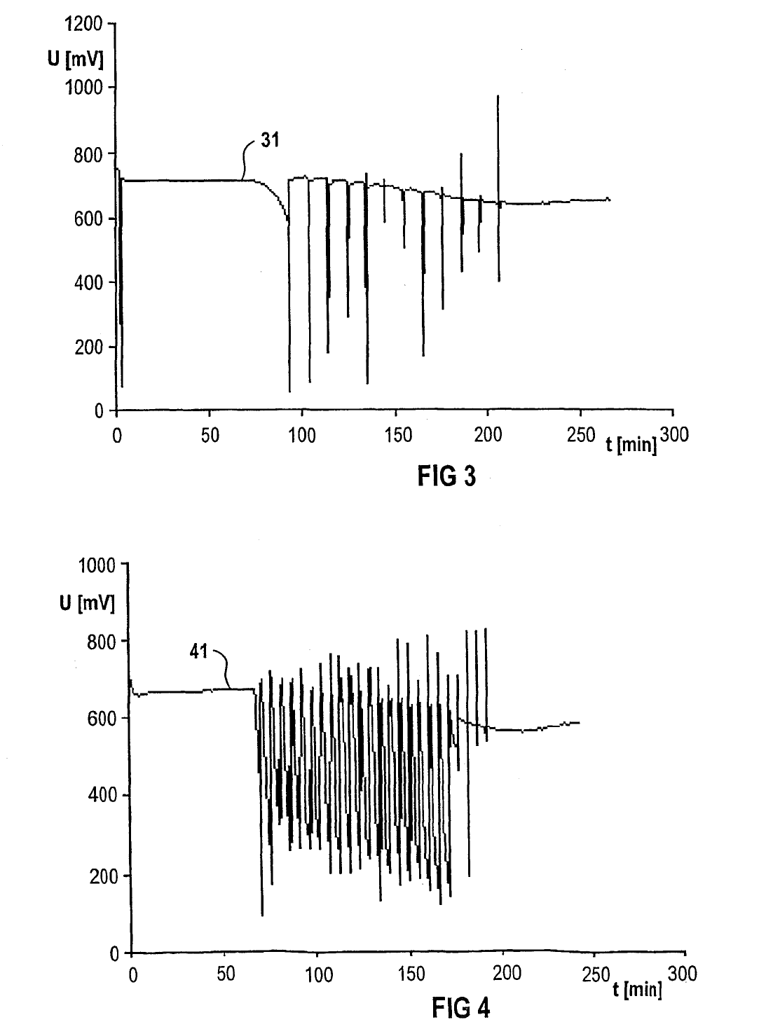

In this context, FIGS. 3 and 4 show the individual voltages U of high-temperature PEM fuel cell units as characteristic curves 31 and 41, respectively, with different levels of CO poisoning as a function of time t, with pulsed operation in each case having been carried out at different time intervals with a predetermined current density. This involves a discharge across a defined resistance for a predetermined discharge time. The characteristic curve 31 represents a CO level of 100 ppm with a pulse of in each case 10 min at 300 mA/m² and a discharge time of 20 s. By contrast, the characteristic curve 41 represents a CO level of 1000 ppm with a pulse of in each case 5 min at 300 A/cm² and a discharge time of 20 s.

In FIGS. 3 and 4, pulsed operation takes place during heating-up of the HT-PEM fuel cell, i.e. before the corresponding operating temperature is reached, since the electrodes may become occupied with carbon monoxide (CO) at the low temperatures. Alternatively, pulsed operation may also take place after heating-up, i.e. once the operating temperature has been reached. It is in this way possible to ensure that the HT-PEM fuel cell is regenerated as a function of the poisoning state. The cell voltage or the change in this voltage can be recorded as a trigger for automatic regeneration of the HT-PEM fuel cell. This means that pulsed operation in each case takes place as a function of the dynamic voltage characteristics.

It has been found that with the methods described it is possible to keep the HT-PEM fuel cell voltage constant even when the fuel gas is contaminated with CO in the region of 100 and 1000 ppm of CO occupation. This confirms a significant advantage for the HT-PEM fuel cell.

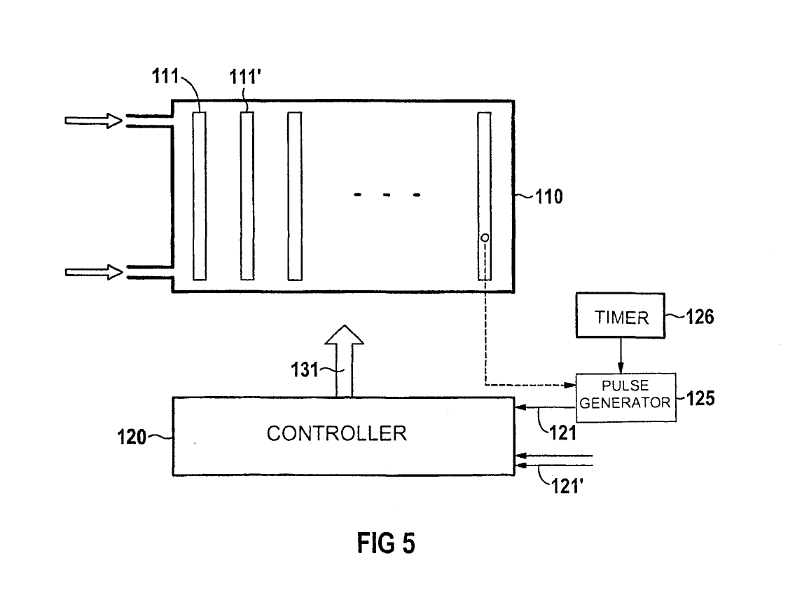

In this context, FIG. 5 shows a fuel cell module 110 which comprises a stack of individual HT-PEM fuel cells 111, 111′, . . . and is known to those of skill in the art as a fuel cell stack or just “stack” for short. The process gas, i.e. hydrogen or hydrogen-rich gas as fuel gas, on the one hand, and oxygen or air as oxidant, on the other hand, are supplied centrally. The stack 110 includes lines for the process gases, which will not be dealt with in further detail in the present context.

In FIG. 5, there is a control device 120, which is used to control the process in the fuel cell stack 110 in a known way. The control device has discrete inputs 121, 121′, . . . for setting process parameters and, for example, one output 131 for a common, optionally bidirectional data bus or a plurality of outputs 131, 131′, . . . for individual control lines.

According to FIG. 5, the control device 120 is assigned a pulsing device 125 which enables the fuel cell system to operate in pulsed mode. There is also a timer 126 which activates the pulsing device 125 in predeterminable operating situations, in particular when the fuel cell system is being started up, but if appropriate also cyclically. In addition to means for recording voltage change gradients at the fuel cell stack, there may also be sensors for recording the occupancy of the electrodes with carbon monoxide, which are indicated in FIG. 5, with the result that the pulsing device 25 can be activated under sensor control in the event that predetermined limit values are exceeded.

For fault-free long-term operation of an HT-PEM fuel cell, it is advantageous if pulsed operation of the fuel cell is carried out routinely after each cold start and running-up to the operating temperature of the HT-PEM fuel cell. In detail, this should involve regeneration of the HT-PEM fuel cell once per operating cycle. The regeneration is carried out in particular in the temperature range from 60° C. to 300° C., which also includes the temperature window of 120° C. to 200° C. which is of importance for the HT-PEM fuel cell.

We claim:

1. A method for operating an HT-PEM fuel cell, which comprises:
starting the HT-PEM fuel cell in a cold state;
operating the HT-PEM fuel cell in pulsed mode operation for a predetermined time, and selecting the time for pulsed mode operation in dependence on at least one of a poisoning state and a cell voltage of the HT-PEM fuel cell; and
thereby regenerating the HT-PEM fuel cell with the pulsed mode operation by alleviating CO poisoning.

2. The method according to claim 1, wherein the regenerating step comprises removing a CO poisoning from electrodes occupied by CO.

3. The method according to claim 1, which comprises operating the HT-PEM fuel cell in pulsed mode operation while the HT-PEM fuel cell is being heated up to operating temperature.

4. The method according to claim 1, which comprises operating the HT-PEM fuel cell in pulsed mode operation after the HT-PEM fuel cell has been heated up substantially to an operating temperature thereof.

5. The method according to claim 1, which comprises operating the HT-PEM fuel cell in pulsed mode operation after each cold start.

6. The method according to claim 1, which comprises regenerating the HT-PEM fuel cell once per operating cycle thereof.

7. The method according to claim 6, which comprises regenerating the HT-PEM fuel cell at temperatures between 60° C. and 30° C.

8. The method according to claim 6, which comprises regenerating the HT-PEM fuel cell at temperatures between 120° C. and 200° C.

9. A fuel cell installation, comprising:
at least one fuel cell module with a fuel cell stack of HT-PEM fuel cells;
a process management control device connected to said fuel cell module;
a pulsing device associated with said control device for activating said fuel cell stack into pulsed operation in dependence on predetermined parameters; and
a device for defining the predetermined parameters, said device including at least one of a device for measuring an output voltage of said fuel cell stack or a change in the output voltage and sensors for recording CO occupation in the HT-PEM fuel cells.

10. The fuel cell installation according to claim 9 configured for the operating method according to claim 1.

11. The fuel cell installation according to claim 9, which comprises a timer for activation of said pulsing device.

12. The fuel cell installation according to claim 9, wherein an activation of said fuel cell stack into pulsed operation is triggered by a given voltage change gradient of said fuel cell stack.

13. The fuel cell installation according to claim 9, wherein an activation of said fuel cell stack into pulsed operation is sensor-controlled.
